(19) United States
(12) Patent Application Publication
(10) Pub. No.: US 2011/0162043 A1
(43) Pub. Date: Jun. 30, 2011

(54) ELECTRONIC APPARATUS INCLUDING SELECTOR FOR CONNECTING FURTHER APPARATUS TO CONTROLLER OR COMMUNICATION CIRCUIT OF ELECTRONIC APPARATUS

(76) Inventor: Takeshi Sakai, Hyogo (JP)

(21) Appl. No.: 13/060,772

(22) PCT Filed: Jul. 21, 2010
(86) PCT No.: PCT/JP2010/004662

§ 371 Date: Feb. 25, 2011

(30) Foreign Application Priority Data
Jul. 23, 2009 (JP) 2009-171710

(51) Int. Cl. G06F 21/00

(52) U.S. Cl. 726/3

(57) ABSTRACT

A controller controls a selector to connect a portable apparatus to the controller, to authenticate the portable apparatus. When the authentication of the portable apparatus is successful, the controller controls the selector to connect the portable apparatus to an audio and visual processing device circuit.

### TECHNICAL FIELD

The present invention relates to an electronic apparatus, which is connected to a further apparatus such as a portable apparatus, authenticates the further apparatus, and receives data such as contents data from the further apparatus.

### BACKGROUND ART

In recent years, there have been spread widely portable apparatus such as iPods (registered trademark) available from Apple Incorporated, capable of playing back various contents data such as video data, music data, or picture data. Further, there have been commonly used electronic apparatuses connected to the above-mentioned portable apparatus to play back the contents data in the portable apparatus at home or in vehicle. Such an electronic apparatus is often provided with a video display function for displaying the contents data or contents information (for example, a video title, a music title, or the like) stored in a portable apparatus to which the electronic apparatus is connected, and a charge function for electrically charging a secondary battery of the portable apparatus (See Patent Document 1, for example).

### CITATION LIST

Patent Document
Patent Document 1: Japanese Patent Laid-open Publication No. JP 2009-88660 A.

### SUMMARY OF INVENTION

### Technical Problem

In order to reduce power consumption of the electronic apparatus described above, there is such an apparatus that is provided with a controller for communicating with the portable apparatus and controlling an entire operation of the electronic apparatus, and a processing circuit such as a video processing device circuit for executing predetermined processings on contents data or contents information received form the portable apparatus and outputting processed data to a video display apparatus. In this case, the controller and the processing circuit are provided separately. Therefore, for example, the contents data or the contents information from the portable apparatus are received by the controller, and thereafter, transferred to the processing circuit. The predetermined processing is executed on the contents data or the contents information, and processed contents data or the contents information are outputted to the video display apparatus. Therefore, there is such a problem that, when a communication speed between the controller and the processing circuit is smaller than a communication speed between the portable apparatus and the electronic apparatus, the electronic apparatus cannot display received contents data or the contents information in the video display apparatus at high speed.

It is an object of the present invention to provide an electronic apparatus capable of solving the above problems, and capable of receiving data such as contents data from a further apparatus such as a portable apparatus, and outputting and the contents data to the video display apparatus to display the contents data at a speed higher than that of the prior art.

### Solution to Problem

An electronic apparatus according to the present invention is an electronic apparatus connected to a further apparatus. The electronic apparatus includes controller means for communicating with the further apparatus to authenticate the further apparatus, communication means for receiving data from the further apparatus, and first switching means for selectively switching over between connecting the further apparatus to the controller means and connecting the further apparatus to the communication means. After controlling the first switching means to connect the further apparatus to the controller means, the controller means communicates with the further apparatus via the first switching means to authenticate the further apparatus. When the authentication of the further apparatus is successful, the controller means controls the first switching means to connect the further apparatus to the communication means.

In the above-mentioned electronic apparatus, when a power switch of the electronic apparatus is turned on, the controller means communicates with the further apparatus via the first switching means to authenticate the further apparatus.

In addition, in the above-mentioned electronic apparatus, upon receiving a command for requesting connection from the further apparatus, the controller means communicates with the further apparatus via the first switching means to authenticate the further apparatus.

Further, in the above-mentioned electronic apparatus, when a power switch of the electronic apparatus is turned off, the controller means controls the first switching means to connect the further apparatus to the controller means.

Still further, the above-mentioned electronic apparatus further includes second switching means for switching over between activation and non-activation of the communication means. When a power switch of the electronic apparatus is turned on, the controller means controls the second switching means to activate the communication means. When the power switch of the electronic apparatus is turned off, the controller means controls the second switching means to stop the operation of the communication means.

In addition, in the above-mentioned electronic apparatus, the further apparatus includes a secondary battery. The controller means (a) receives data of a charge amount of the secondary battery from the further apparatus via the first switching means when the further apparatus is connected to the controller means, and (b) receives the data of the charge amount of the secondary battery from the communication means when the further apparatus is connected to the communication means, the data being received by the communication means via the first switching means.

Further, the above-mentioned electronic apparatus further includes third switching means for switching over between application and non-application of a predetermined DC voltage to the secondary battery. The controller means controls the third switching means based on received data of the charge amount of the secondary battery so that the charge amount of the secondary battery becomes a predetermined threshold value.

Still further, in the above-mentioned electronic apparatus, the data received from the further apparatus is contents data including at least one of audio data and video data.

### Advantageous Effects of Invention

The electronic apparatus according to the present invention includes the first switching means for selectively switching over between connecting the further apparatus to the controller means and connecting the further apparatus to the communication means, and the controller means communicates with the further apparatus via the first switching means to authenticate the further apparatus, and controls the first switching means to connect the further apparatus to the communication means when the authentication of the further apparatus is successful. Therefore, after the successful authentication of the further apparatus, the communication means can communicate directly with the further apparatus not via the controller means. Therefore, it is possible to realize the electronic apparatus capable of receiving contents data or contents information from a further apparatus such as a portable apparatus, and outputting the contents data or the contents information to the video display apparatus to display the contents data or the contents information at a speed higher than that of the prior art.

### BRIEF DESCRIPTION OF DRAWINGS

FIG. 1 is a block diagram showing a theater system apparatus 60 according to a first preferred embodiment of the present invention, a portable apparatus 40, a video display apparatus 70, and a loudspeaker 80.

FIG. 2 is a flowchart of a first part of an apparatus control processing executed by a controller 2 of FIG. 1.

FIG. 3 is a flowchart of a second part of the apparatus control processing executed by the controller 2 of FIG. 1.

FIG. 4 is a flowchart of a third part of the apparatus control processing executed by the controller 2 of FIG. 1.

FIG. 5 is a flowchart of a first charge processing at step S3 of FIG. 2.

FIG. 6 is a flowchart of second charge processing at step S11 of FIG. 2.

FIG. 7 is a table showing relations among an on-off state of a power switch 8, an on-off state of a device connection detecting switch 9, switching states of power supply switches 4 and 5, and a switching state of a selector 6 realized by the apparatus control processing of FIG. 2 and FIG. 3.

FIG. 8 is a flowchart of a first part of an apparatus control processing according to a second preferred embodiment of the present invention.

### DESCRIPTION OF EMBODIMENTS

Preferred embodiments according to the present invention will be described below with reference to the attached drawings. Components similar to each other are denoted by the same reference numerals and will not be described herein in detail.

### First Preferred Embodiment

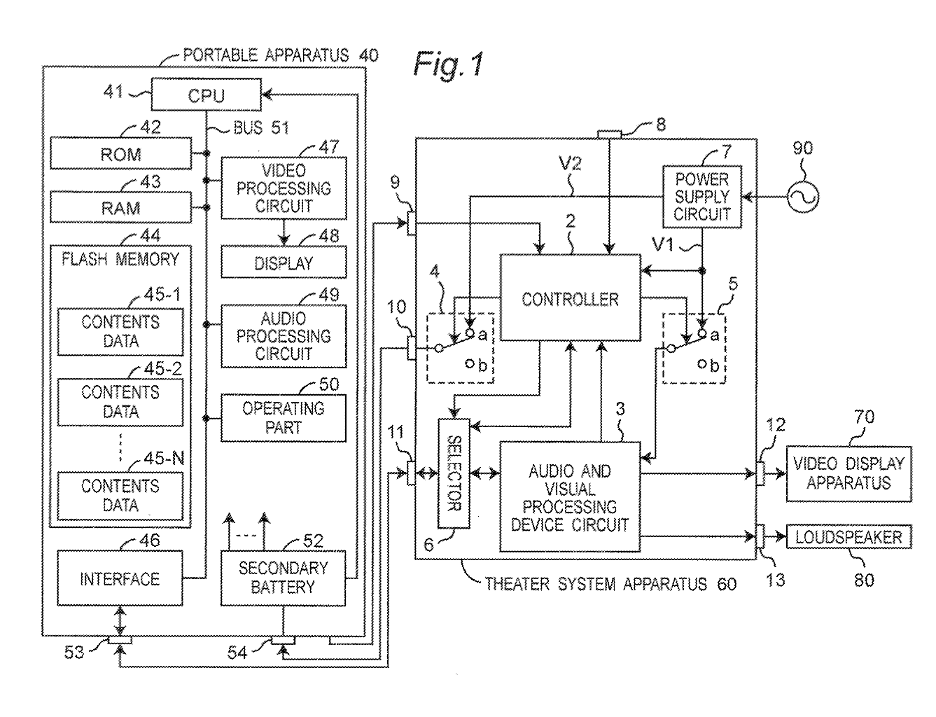

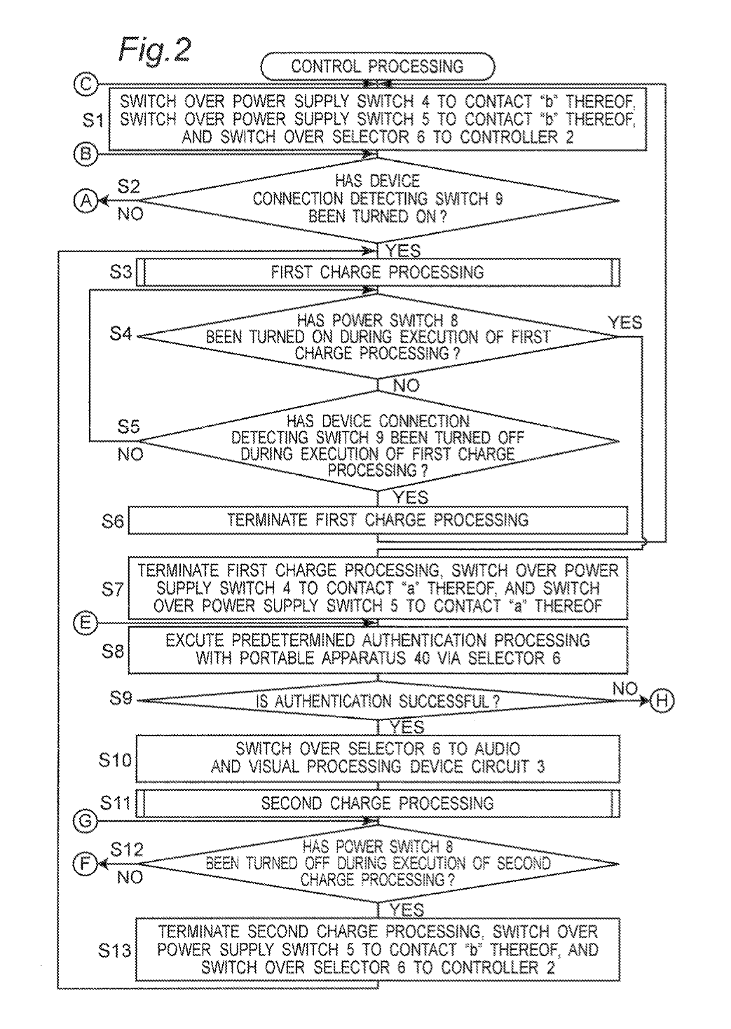

FIG. 1 is a block diagram showing a theater system apparatus 60 according to a first preferred embodiment of the present invention, a portable apparatus 40, a video display apparatus 70, and a loudspeaker 80. In addition, FIG. 2 to FIG. 4 are flowcharts of an apparatus control processing executed by a controller 2 of FIG. 1.

As will be described in detail later, the theater system apparatus 60 according to the present preferred embodiment includes:

(a) the controller 2 for communicating with the portable apparatus 40 to authenticates the portable apparatus 40;

(b) an audio and visual processing device circuit 3 for receiving contents data 45-n (n=1, 2, . . . , and N, where N is a positive integer) from the portable apparatus 40; and

(c) a selector 6 for selectively switching over between connecting the portable apparatus 40 to the controller 2 and connecting the portable apparatus 40 to the audio and visual processing device circuit 3. In this case, the controller 2 communicates with the portable apparatus 40 via the selector 6 after controlling the selector 6 to connect the portable apparatus 40 to the controller 2 to authenticate the portable apparatus 40, and controls the selector 6 to connect the portable apparatus 40 to the audio and visual processing device circuit 3 when the authentication of the portable apparatus 40 is successful.

First of all, a configuration of the portable apparatus 40 is described with reference to FIG. 1. The portable apparatus 40 is a well-known portable media player, and used as a user terminal apparatus for storing and playing back the contents data 45-1 to 45-N such as video data, picture data, music data, text data, and the like. The portable apparatus 40 is configured to include a CPU (Central Processing Unit) 41, a ROM (Read Only Memory) 42, a RAM (Random Access Memory) 43, a flash memory 44, an interface 46, a video processing circuit 47, a display 48, an audio processing circuit 49, an operating unit 50, a bus 51, a secondary battery 52, an input and output terminal 53, and a power terminal 54. The CPU 41 is connected to the ROM 42, the RAM 43, the flash memory 44, the interface 46, the video processing circuit 47, the audio processing circuit 49, and the operating unit 50 via the bus 51, and controls these components to execute various software functions. Further, the CPU 41 detects a charge amount of the secondary battery 52. It should be noted that, the CPU 41 controls the operation of the portable apparatus 40, however, the descriptions of the CPU 41 will be omitted herein.

Referring to FIG. 1, the ROM 42 previously stores various software programs that are required for the operation of the portable apparatus 40 and are executed by the CPU 41. In addition, the RAM 43 is configured to include an SRAM (Static RAM), a DRAM (Dynamic RAM), or an SDRAM (Synchronous DRAM), and is used as a working area of the CPU 41. The RAM 43 stores therein temporary data generated when the CPU 41 executes the programs. Further, the flash memory 44 is a storage apparatus having a built-in recording medium, and stores the contents data 45-1 to 45-N such as video data, picture data, music data, text data, and the like.

The interface 46 complies with the USB (Universal Serial Bus) 2.0, and is connected to an input and output terminal 11 of the theater system apparatus 60 via the input and output terminal 53. The interface 46 receives a signal and data from the theater system apparatus 60 and transmits a signal and data to the theater system apparatus 60 while executing an interface processing relating to serial communication such as a signal conversion and a protocol conversion. In addition, the video processing circuit 47 executes a predetermined signal processing and a D/A conversion processing on each of the contents data 45-1 to 45-N such as video data and picture data, and image data, which are outputted by the programs executed by the CPU 41 and are used as user interfaces. Then, the video processing circuit 47 outputs processed data to the display 48 so as to display the processed data. In this case, the image data which are used as user interfaces include, for example, image data indicating the charge amount of the secondary battery 52, image data indicating a list of the contents data 45-1 to 45-N stored in the flash memory 44, image data indicating contents information (for example, a title of music) included in each of the contents data 45-1 to 45-N, image data indicating an operational state of the portable apparatus 40, or the like. The audio processing circuit 49 executes a predetermined signal processing and a D/A conversion processing on the contents data 45-1 to 45-N such as music data. In addition, the operating unit 50 includes, for example, a playback and stop button and a menu button, and is provided for allowing a user to input instruction commands for operating the portable apparatus 40.

Referring to FIG. 1, the secondary battery 52 is a lithium-ion storage battery, for example, and supplies power to each of the circuits 41-44, 46-49 and the like of the portable apparatus 40. In addition, the secondary battery 52 is connected to a power supply circuit 7 of the theater system apparatus 60 via the power terminal 54, a power supply terminal 10, and a contact “a” of a power supply switch 4, and is electrically charged by the theater system apparatus 60 as will be described in detail later.

Next, a configuration of the theater system apparatus 60 is described with reference to FIG. 1. The theater system apparatus 60 is an electronic apparatus configured to include the controller 2 of a microcomputer for controlling, the audio and visual processing device circuit 3 of an LSI (Large Scale Integration), the power supply switch 4, a power supply switch 5, the selector 6, the power supply circuit 7, a power switch 8, a device connection detecting switch 9, the power supply terminal 10, the input and output terminal 11, a video output terminal 12, and an audio output terminal 13. In addition, the theater system apparatus 60 is configured so that, when the portable apparatus 40 is installed at a predetermined connecting position of the theater system apparatus 60, the device connection detecting switch 9 is turned on, the power supply terminal 10 and the power terminal 54 are electrically connected to each other, and the input and output terminal 11 and the input and output terminal 53 are electrically connected to each other. When the portable apparatus 40 is removed from the predetermined connecting position of the theater system apparatus 60, the device connection detecting switch 9 is turned off. In this case, both of the contact “a” of the power supply switch 4 and a contact “a” of the power supply switch 5 are connected to the power supply circuit 7, and both of a contact “b” of the power supply switch 4 and a contact “b” of the power supply switch 5 are both open. The power supply circuit 7 converts an AC voltage from a commercial power supply 90 into a DC voltage V1 for activating the controller 2 and the audio and visual processing device circuit 3, and a DC voltage V2 for electrically charging the secondary battery 52 of the portable apparatus 40. The DC voltage V1 is outputted to the controller 2, and is outputted to the audio and visual processing device circuit 3 via the contact “a” of the power supply switch 5. In addition, the DC voltage V2 is outputted to the secondary battery 52 via the contact “a” of the power supply switch 4, the power supply terminal 10, and the power terminal 54. Further, the selector 6 selectively switches over between connecting the portable apparatus 40 to the controller 2 via the input and output terminal 53 and the input and output terminal 11, and connecting the portable apparatus 40 to the audio and visual processing device circuit 3 via the input and output terminal 53 and the input and output terminal 11.

The power switch 8 is provided in order to turn-on and -off the theater system apparatus 60. In this case, a state in which the theater system apparatus 60 is turned off refers to a state in which the theater system apparatus 60 is connected to the commercial power supply 90 and the DC voltage V1 from the power supply circuit 7 is outputted only to the controller 2. In this case, the DC voltage V1 is not applied to the audio and visual processing device circuit 3, and the audio and visual processing device circuit 3 is not activated. In addition, a state in which the theater system apparatus 60 is turned on refers to a state in which the theater system apparatus 60 is connected to the commercial power supply 90 and the DC voltage V1 from the power supply circuit 7 is outputted to the controller 2 and the audio and visual processing device circuit 3. In this case, the DC voltage V1 is applied to the audio and visual processing device circuit 3, and the audio and visual processing device circuit 3 is activated. In addition, the device connection detecting switch 9 is configured to be electrically turned on when the portable apparatus 40 is installed at the predetermined connecting position. When the theater system apparatus 60 is connected to the commercial power supply 90, regardless of the on-off state of the power switch 8, the DC voltage V1 is always applied to the controller 2 from the power supply circuit 7, and the controller 2 can detect the on-off states of the power switch 8 and the device connection detecting switch 9, respectively. Then, as will be described in detail later, based on results of the detection of the respective on-off states of the power switch 8 and the device connection detecting switch 9, the controller 2 controls respective operations of the power supply switch 4, the power supply switch 5, and the selector 6.

In addition, the audio and visual processing device circuit 3 is communication means for transmitting and receiving data to and from the portable apparatus 40, and receives the contents data 45-n including at least one of audio data and video data, or the contents information from the portable apparatus 40. The audio and visual processing device circuit 3 executes a predetermined signal processing and a D/A conversion processing on the video data included in the contents data 45-n or the contents information inputted from the portable apparatus 40 via the selector 6, and thereafter, outputs processed contents data 45-n or the contents information to the video display apparatus 70 such as a display to display the processed contents data 45-n or the contents information. Further, the audio and visual processing device circuit 3 executes a predetermined signal processing and a D/A conversion processing to the audio data included in the contents data 45-n or the contents information inputted from the portable apparatus 40 via the selector 6, and then outputs processed contents data 45-n or the contents information to the loudspeaker 80. Further, the audio and visual processing device circuit 3 outputs data including the charge amount of the secondary battery 52, which is inputted from the portable apparatus 40 via the selector 6, to the controller 2.

Next, the apparatus control processing executed by the controller 2 is described with reference to FIG. 2 to FIG. 6. The apparatus control processing is executed when the commercial power supply 90 is supplied to the power supply circuit 7 and the DC voltage V1 is applied to the controller 2 from the power supply circuit 7. In this case, the power switch 8 and the device connection detecting switch 9 are turned off. First of all, at step S1, the controller 2 switches over the power supply switch 4 to the contact “b” thereof, switches over the power supply switch 5 to the contact “b” thereof, and switches over the selector 6 to the controller 2. With this processing, the portable apparatus 40 is not connected to the power supply circuit 7, the audio and visual processing device circuit 3 is not activated, and the portable apparatus 40 is connected to the controller 2. Next, at step S2, it is determined whether or not the device connection detecting switch 9 has been turned on (i.e., whether or not the portable apparatus 40 has been installed at the predetermined connecting position of the theater system apparatus 60). If YES at step S2, then the control flow goes to step S3. On the other hand, if NO at step S2, then the control flow goes to step S16. At step S3, the first charge processing of FIG. 5 is executed.

During the first charge processing of FIG. 5, the selector 6 is switched over to the controller 2, and the portable apparatus 40 is connected to the controller 2. At step S31 of FIG. 5, the controller 2 switches over the power supply switch 4 to the contact “a” thereof. Then, at step S32, the controller 2 transmits a command for requesting the portable apparatus 40 to transmit the data of the charge amount of the secondary battery 52, to the portable apparatus 40 via the selector 6, and receives the data of the charge amount of the secondary battery 52 transmitted from the portable apparatus 40 in response to the command via the selector 6. Subsequently, at step S33, it is determined whether or not the charge amount of the secondary battery 52 is larger than a predetermined threshold value. If YES at step S33, then the control flow goes to step S34. On the other hand, if NO at step S33, then the control flow goes to step S35. At step S34, the power supply switch 4 is switched over to the contact “b” thereof, and the control flow returns to step S32. In addition, at step S35, the power supply switch 4 is switched over to the contact “a” thereof, and the control flow returns to step S32. It should be noted that the controller 2 executes the processings at step S32 at a predetermined time cycle.

Referring back to FIG. 2, at step S4, it is determined whether or not the power switch 8 has been turned on during the execution of the first charge processing of step S3. If YES at step S4, then the control flow goes to step S7. On the other hand, if NO at step S4, then the control flow goes to step S5. Then, at step S5, it is determined whether or not the device connection detecting switch 9 has been turned off during the execution of first charge processing (i.e., whether or not the portable apparatus 40 has been removed from the predetermined connecting position of the theater system apparatus 60). If YES at step S5, then the first charge processing is terminated at step S6, and the control flow returns to step S1. On the other hand, if NO at step S5, then the control flow returns to step S4.

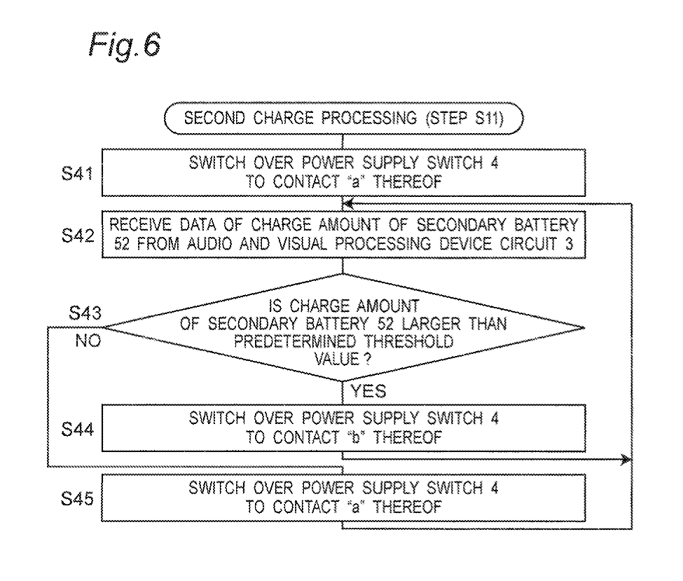

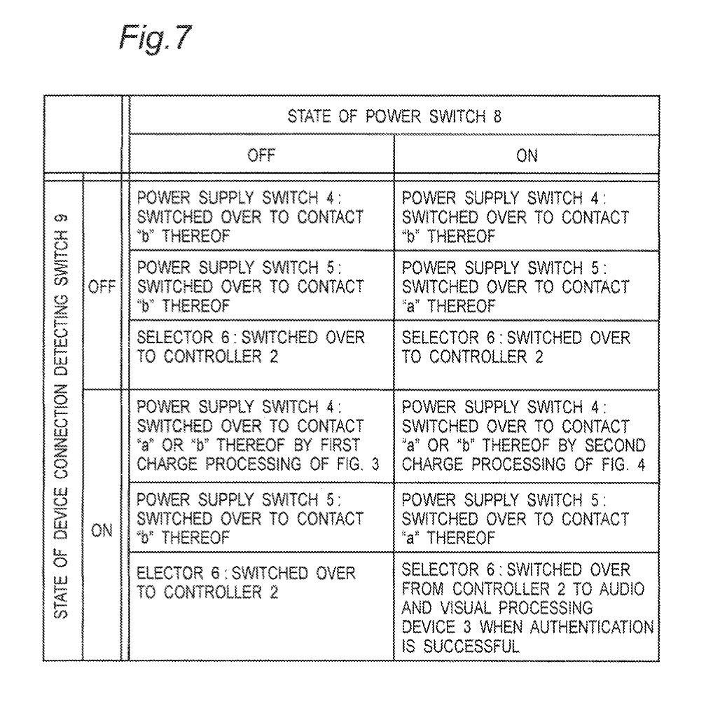

At step S7, the controller 2 terminates the first charge processing, switches over the power supply switch 4 to the contact “a” thereof, and switches over the power supply switch 5 to the contact “a” thereof. With this processing, the DC voltage V1 is applied to the audio and visual processing device circuit 3. Subsequently, at step S8, the controller 2 executes a predetermined authentication processing with the portable apparatus 40 via the selector 6, and then the control flow goes to step S9. In this case, the authentication processing executed at step S8 is a provided for authenticating communication with the portable apparatus 40 and receiving and playing back the contents data 45-n in the portable apparatus 40. At step S9, it is determined whether or not the authentication of the portable apparatus 40 is successful. If YES at step S9, then the control flow goes to step S10. On the other hand, if NO at step S9, then the control flow goes to step S21. Then, at step S10, the controller 2 switches over the selector 6 to the audio and visual processing device circuit 3, and at step S11, the controller 2 executes a second charge processing of FIG. 6. It should be noted that, at step S10, when the selector 6 is switched over to the audio and visual processing device circuit 3, the portable apparatus 40 is connected to the audio and visual processing device circuit 3. The audio and visual processing device circuit 3 receives the contents data 45-n or the contents information from the portable apparatus 40 via the selector 6, generates video data and audio data based on received contents data 45-n or the contents information, outputs the video data to the video display apparatus 70 to display the video data, and outputs the audio data to the loudspeaker 80. Further, the audio and visual processing device circuit 3 transmits the command for requesting the portable apparatus 40 to transmit the data of the charge amount of the secondary battery 52, to the portable apparatus 40 via the selector 6 at a predetermined time cycle, and receives the data of the charge amount of the secondary battery 52 transmitted from the portable apparatus 40 via the selector 6 in response to the command. Then, the audio and visual processing device circuit 3 outputs received data of the charge amount to the controller 2.

During the second charge processing of FIG. 6, the selector 6 is switched over to the audio and visual processing device circuit 3, and the portable apparatus 40 is connected to the audio and visual processing device circuit 3. At step S41 of FIG. 6, the controller 2 receives the data of the charge amount of the secondary battery 52 from the audio and visual processing device circuit 3. Subsequently, at step S43, it is determined whether, t or not the charge amount of the secondary battery 52 is larger than a predetermined threshold value. If YES at step S43, then the control flow goes to step S44. On the other hand, if NO at step S43, then the control flow goes to step S45. At step S44, the power supply switch 4 is switched over to the contact “b” thereof, and the control flow returns to step S42. In addition, at step S45, the power supply switch 4 is switched over to the contact “a” thereof, and the control flow returns to step S42.

Referring back to FIG. 2, at step S12, it is determined whether or not the power switch 8 has been turned off during the execution of the second charge processing. If YES at step S12, then the control flow goes to step S13. On the other hand, if NO at step S12, then the control flow goes to step S14. At step S13, the controller 2 terminates the second charge processing, switches over the power supply switch 5 to the contact “b” thereof, and switches over the selector 6 to the controller 2, and the control flow returns to step S3. On the other hand, at step S14, it is determined whether or not the device connection detecting switch 9 has been turned off during the second charge processing. If YES at step S14, then the control flow goes to step S15. On the other hand, if NO at step S14, then the control flow returns to step S12. At step S15, the controller 2 switches over the power supply switch 4 to the contact “b” thereof, and switches over the selector 6 to the controller 2, and the control flow goes to step S18.

At step S16, it is determined whether or not the power switch 8 has been turned on. If YES at step S16, then the control flow goes to step S17. On the other hand, if NO at step S16, then the control flow returns to step S2. At step S17, the controller 2 switches over the power supply switch 5 to the contact “a” thereof, and the control flow goes to step S18. At step S18, it is determined whether or not the power switch 8 has been turned off. If YES at step S18, then the control flow returns to step S1. On the other hand, if NO at step S18, then the control flow goes to step S19. Further, at step S19, it is determined whether or not the device connection detecting switch 9 has been turned on. If YES at step S19, then the control flow goes to step S20. On the other hand, if NO at step S19, then the control flow returns to step S18. At step S20, the power supply switch 4 is switched over to the contact “a” thereof, and the control flow returns to step S8.

In addition, when the authentication is unsuccessful at step S9, the controller 2 switches over the power supply switch 4 to the contact “b” thereof at step S21, and the control flow goes to step S22. At step S22, it is determined whether or not the power switch 8 has been turned off. If YES at step S22, then the control flow returns to step S1. On the other hand, if NO at step S22, then the control flow goes to step S23. Then, at step S23, it is determined whether or not the device connection detecting switch 9 has been turned on. If YES at step S23, then the control flow goes to step S18. On the other hand, if NO at step S23, then the control flow returns to step S22.

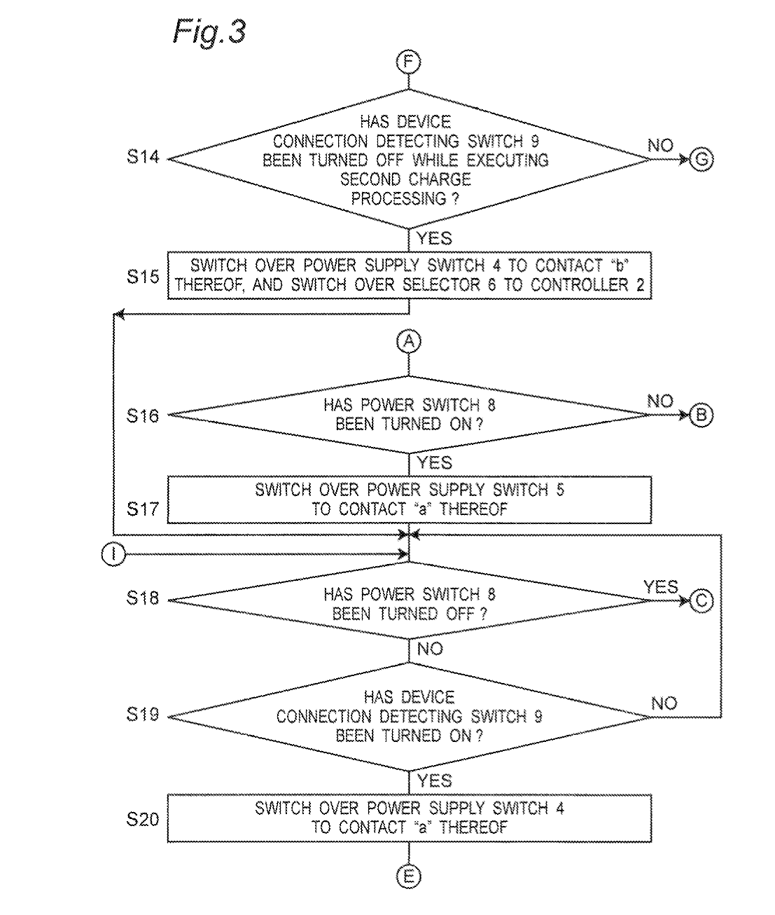

FIG. 7 is a table showing relations among the on-off state of the power switch 8, the on-off state of the device connection detecting switch 9, the switching states of the power supply switches 4 and 5, and the switching state of the selector 6 realized by the apparatus control processing of FIG. 2 and FIG. 3. Referring to FIG. 7, according to the apparatus control processing of the present preferred embodiment, when the portable apparatus 40 is connected to the theater system apparatus 60 (i.e., the device connection detecting switch 9 is turned on) and the power switch 8 is turned off, the power supply switch 5 is switched over to the contact “b” thereof and the selector 6 is switched over to the controller 2. Then, by executing the first charge processing, the controller 2 receives the data of the charge amount of the secondary battery 52 from the portable apparatus 40 via the selector 6, and electrically charges the secondary battery 52 so that the charge amount substantially becomes the predetermined threshold value.

In addition, when the portable apparatus 40 is connected to the theater system apparatus 60 (i.e., the device connection detecting switch 9 is turned on) and the power switch 8 is turned on, the power supply switch 5 is switched over to the contact “a” thereof and the DC voltage V1 is applied to the audio and visual processing device circuit 3. In addition, the controller 2 supplies power to the portable apparatus 40 by switching over the power supply switch 4 to the contact “a” thereof, and switches over the selector 6 to the controller 2 to execute the authentication processing with the portable apparatus 40 via the selector 6. Then, when the authentication of the portable apparatus 40 is successful, the controller 2 switches over the selector 6 to the audio and visual processing device circuit 3. Therefore, after the successful authentication, the portable apparatus 40 communicates with the audio and visual processing device circuit 3, and transmits the contents data 45-n and the data of the charge amount of the secondary battery 52 to the audio and visual processing device circuit 3. Further, after the successful authentication, by executing the second charge processing, the controller 2 receives the data of the charge amount of the secondary battery 52 from the audio and visual processing device circuit 3, and electrically charges the secondary battery 52 so that the charge amount substantially becomes the predetermined threshold value.

As described above, according to the present preferred embodiment, after controlling the selector 6 to connect the portable apparatus 40 to the controller 2, the controller 2 communicates with the portable apparatus 40 via the selector 6 to authenticate the portable apparatus 40 (step S8 of FIG. 2). Since the controller 2 switches over the selector 6 to the audio and visual processing device circuit 3 when the authentication of the portable apparatus 40 is successful (step S10 of FIG. 2), the contents data 45-n from the portable apparatus 40 is transmitted to the audio and visual processing device circuit 3 not via the controller 2. Therefore, the video data included in the received contents data 45-n can be displayed in the video display apparatus 70 at a speed higher than that of the prior art.

In addition, the controller 2 communicates with the portable apparatus 40 via the selector 6 to authenticate the portable apparatus 40 when the power switch 8 of the theater system apparatus 60 is turned on (when YES at step S4 of FIG. 2). Therefore, it is possible to authenticate the portable apparatus 40 without fail when the power switch 8 is turned on.

Further, the controller 2 controls the selector 6 to connect the portable apparatus 40 to the controller 2 when the power switch 8 of the theater system apparatus 60 is turned off (step S1 and step S13 of FIG. 2). Therefore, even after the power switch 8 is turned off, the controller 2 can communicate with the portable apparatus 40, and, for example, the controller 2 can receive the data of the charge amount of the secondary battery 52 from the portable apparatus 40.

Still further, the theater system apparatus 60 includes the power supply switch 5 for switching over between activation and non-activation of the audio and visual processing device circuit 3, and the controller 2 switches over the power supply switch 5 to the contact “a” thereof when the power switch 8 is turned on so as to activate the audio and visual processing device circuit 3, and switches over the power supply switch 5 to the contact “b” thereof when the power switch 8 is turned off so as to stop the operation of the audio and visual processing device circuit 3. Therefore, since the power is not supplied to the audio and visual processing device circuit 3 when the power switch 8 is turned off, it is possible to minimize the power consumption of the theater system apparatus 60.

In addition, the controller 2 receives the data of the charge amount of the secondary battery 52 from the portable apparatus 40 via the selector 6 when the controller 2 is connected to the portable apparatus 40, and receives the data of the charge amount of the secondary battery 52, which is received by the audio and visual processing device circuit 3 via the selector 6, when the portable apparatus 40 is connected to the audio and visual processing device circuit 3. Therefore, it is possible to receive the data of the charge amount of the secondary battery 52 and to monitor the charge amount of the secondary battery 52 regardless of the on-off state of the power switch 8.

Further, the theater system apparatus 60 includes the power supply switch 4 for switching over between application and non-application of the DC voltage V1 to the secondary battery 52, and the controller 2 controls the power supply switch 4 based on the received data of the charge amount of the secondary battery 52 so that the charge amount of the secondary battery becomes the predetermined threshold value. Therefore, it is possible to electrically charge the secondary battery 52 so that the charge amount substantially becomes the predetermined threshold value.

### Second Preferred Embodiment

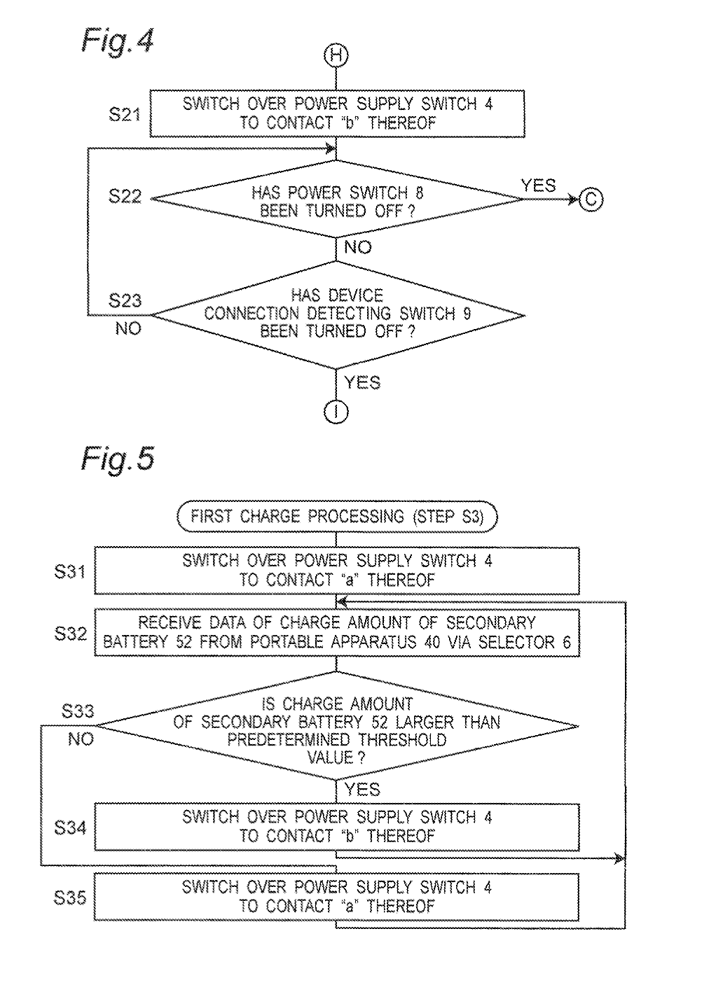

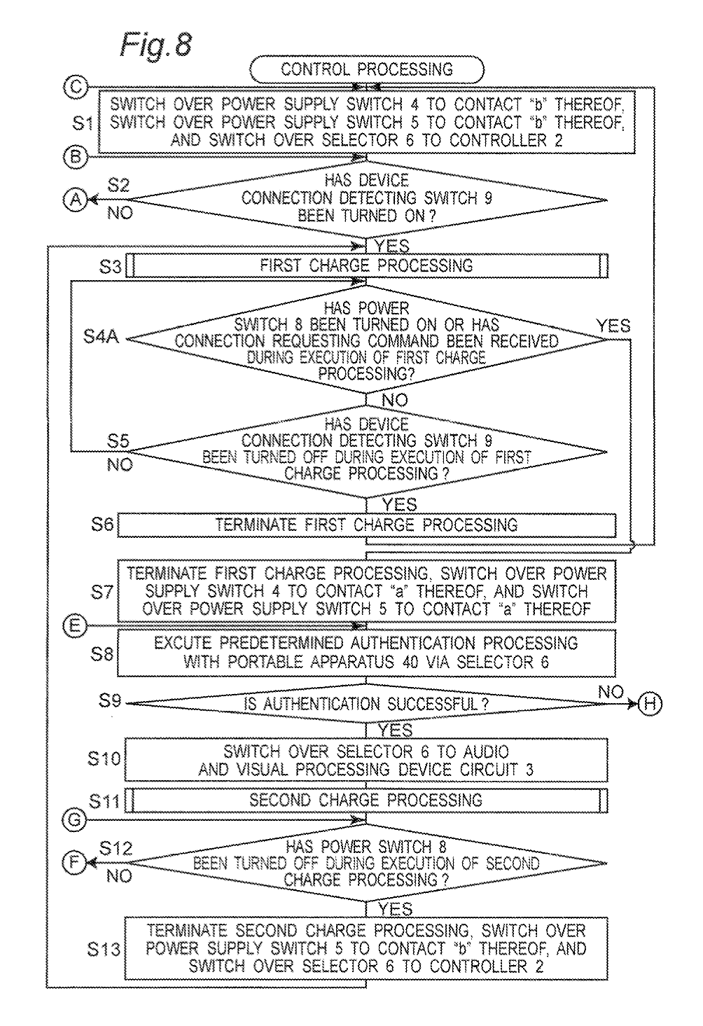

FIG. 8 is a flowchart of a first part of apparatus control processing according to a second preferred embodiment of the present invention. It should be noted that both of a second part and a third part of the apparatus control processing according to the second preferred embodiment are the same as the second part (FIG. 3) and the third part (FIG. 4) of the apparatus control processing according to the first preferred embodiment, respectively. The processing of FIG. 8 is such that step S4 of the processing of FIG. 2 is replaced with step S4A. At step S4A, the controller 2 determines whether or not the power switch 8 has been turned on or a connection requesting command has been received from the portable apparatus 40 during the execution of first charge processing. In this case, the connection requesting command is a command for requesting the theater system apparatus 60 to connect to the theater system apparatus 60, and is transmitted from the portable apparatus 40 to the theater system apparatus 60 when a user operates a playback button or the like of the operating unit 50 of the portable apparatus 40. Therefore, according to the present preferred embodiment, it is possible to output the video data to the display apparatus 70 to display the video data, and to output sound from the loudspeaker 80, when the user operates the playback button or the like of the operating unit 50 of the portable apparatus 40, regardless of the on-off state of the power switch 8.

It should be noted that, in the above preferred embodiments, the interface 46 is the interface circuit complying with the standards of USB 2.0, however, the present invention is not limited to this. The interface 46 may be an UART (Universal Asynchronous Receiver Transmitter) integrated circuit.

In addition, in the above preferred embodiments, the portable apparatus 40 and the theater system apparatus 60 are wirely connected to each other, however, the present invention is not limited to this, and the portable apparatus 40 and the theater system apparatus 60 may be wirelessly connected to each other.

Further, in the above preferred embodiments, when the power switch 8 is turned off, the controller 2 switches over the power supply switch 4 to the contact “b” thereof if the charge amount of the secondary battery 52 is larger than the predetermined threshold value by executing the first charge processing, however, the present invention is not limited to this. The controller 2 may display image data instructing the user to disconnect the portable apparatus 40 in the video display apparatus 70 via the audio and visual processing device circuit 3.

In the above preferred embodiments, the description is given taking the example of the theater system apparatus 60, however, the present invention is not limited to this. It is possible to employ any electronic apparatus that is connected to a further apparatus such as the portable apparatus 40 or the like.

### INDUSTRIAL APPLICABILITY

As described above in detail, the electronic apparatus according to the present invention includes the first switching means for selectively switching over between connecting the further apparatus to the controller means and connecting the further apparatus to the communication means, and the controller means communicates with the further apparatus via the first switching means to authenticate the further apparatus, and controls the first switching means to connect the further apparatus to the communication means when the authentication of the further apparatus is successful. Therefore, after the successful authentication of the further apparatus, the communication means can communicate directly with the further apparatus not via the controller means. Therefore, it is possible to realize the electronic apparatus capable of receiving contents data or contents information from a further apparatus such as a portable apparatus, and outputting the contents data or the contents information to the video display apparatus to display the contents data or the contents information at a speed higher than that of the prior art.

### REFERENCE SIGNS LIST

2 . . . Controller,
3 . . . Audio and Visual Processing Device Circuit,
4 . . . Power Supply Switch,
5 . . . Power Supply Switch,
6 . . . Selector,
7 . . . Power Supply Circuit,
8 . . . Power Switch,
9 . . . Device Connection Detecting Switch,
10 . . . Power Supply Terminal,
11 . . . Input and Output Terminal,
12 . . . Video Output Terminal,
13 . . . Audio Output Terminal,
40 . . . Portable Apparatus,
41 . . . CPU,
42 . . . ROM,
43 . . . RAM,
44 . . . Flash Memory,
45-1 to 45-N . . . Contents Data,
46 . . . Interface,
47 . . . Video Processing Circuit,
48 . . . Display,
49 . . . Audio Processing Circuit,
50 . . . Operating Unit,
51 . . . Bus,
52 . . . Secondary Battery,
53 . . . Input and Output Terminal,
54 . . . Power Terminal,
60 . . . Theater System Apparatus,
70 . . . Video Display Apparatus, and
80 . . . Loudspeaker.

1-8. (canceled)

9. An electronic apparatus connected to a further apparatus, the electronic apparatus comprising:
a controller for communicating with the further apparatus to authenticate the further apparatus;
a communication circuit for receiving data from the further apparatus; and
a first switch for selectively switching over between connecting the further apparatus to the controller and connecting the further apparatus to the communication circuit,
wherein, after controlling the first switch to connect the further apparatus to the controller, the controller communicates with the further apparatus via the first switch to authenticate the further apparatus, and
wherein, when the authentication of the further apparatus is successful, the controller controls the first switch to connect the further apparatus to the communication circuit.

10. The electronic apparatus as claimed in claim 9,
wherein, when a power switch of the electronic apparatus is turned on, the controller communicates with the further apparatus via the first switch to authenticate the further apparatus.

11. The electronic apparatus as claimed in claim 9,
wherein, upon receiving a command for requesting connection from the further apparatus, the controller communicates with the further apparatus via the first switch to authenticate the further apparatus.

12. The electronic apparatus as claimed in claim 9,
wherein, when a power switch of the electronic apparatus is turned off, the controller controls the first switch to connect the further apparatus to the controller.

13. The electronic apparatus as claimed in claim 9, further comprising a second switch for switching over between activation and non-activation of the communication circuit,
wherein, when a power switch of the electronic apparatus is turned on, the controller controls the second switch to activate the communication circuit, and
wherein, when the power switch of the electronic apparatus is turned off, the controller controls the second switch to stop the operation of the communication circuit.

14. The electronic apparatus as claimed in claim 9,
wherein the further apparatus comprises a secondary battery, and
wherein the controller
(a) receives data of a charge amount of the secondary battery from the further apparatus via the first switch when the further apparatus is connected to the controller, and
(b) receives the data of the charge amount of the secondary battery from the communication circuit when the further apparatus is connected to the communication circuit, the data being received by the communication circuit via the first switch.

15. The electronic apparatus as claimed in claim 14, further comprising a third switch for switching over between application and non-application of a predetermined DC voltage to the secondary battery,
wherein the controller controls the third switch based on received data of the charge amount of the secondary battery so that the charge amount of the secondary battery becomes a predetermined threshold value.

16. The electronic apparatus as claimed in claim 9,
wherein the data received from the further apparatus is contents data including at least one of audio data and video data.
